(19) United States
(12) Patent Application Publication
(10) Pub. No.: US 2020/0066052 A1
(43) Pub. Date: Feb. 27, 2020

(54) SYSTEM AND METHOD OF SUPERIMPOSING A THREE-DIMENSIONAL (3D) VIRTUAL GARMENT ON TO A REAL-TIME VIDEO OF A USER

(71) Applicant: CJ Technologies, LLC, Thousand Oaks, CA (US)

(72) Inventors: Christopher Paul Antonsen, Westlake Village, CA (US); Syed Faisal Shah, Lahore (PK); John Kennedy, Simi Valley, CA (US)

(21) Appl. No.: 16/550,027

(22) Filed: Aug. 23, 2019

Related U.S. Application Data
(60) Provisional application No. 62/721,925, filed on Aug. 23, 2018.
(60) Provisional application No. 62/721,928, filed on Aug. 23, 2018.

(51) Int. Cl. G06T 19/00; G06T 19/20; G06Q 30/06

(52) U.S. Cl. CPC G06T 19/006; G06T 2219/2016; G06Q 30/0643; G06T 19/20

(57) ABSTRACT

A system and a method for superimposing a garment onto an image or a real-time video of a user are disclosed. After a person captures an image or video of them self and after the person selects a garment that they wish to see them self virtually wearing, instructions executed by a processor may be used to overlay an image of the selected garment onto the image or video of the person. Images or a real-time video of the person may be captured from a reflection of the person in a mirror after which a computing device may generate a combined image of the person that depicts that person wearing a selected garment. Images of the garment overlaid over the captured images or video may show a user how the garment looks on their body from different angles or perspectives when they cannot physically touch the garment.

### CROSS REFERENCE TO RELATED APPLICATIONS

This application claims priority benefit of U.S. provisional application 62/721,925 filed on Aug. 23, 2018, and provisional patent application 62/721,928 filed on Aug. 23, 2018 the disclosures of which are incorporated herein by reference.

### BACKGROUND OF THE INVENTION

### Field of Invention

The present disclosure is generally related to augmented images. More specifically the present disclosure is related to superimposing an image of a garment over an image of a person.

### BACKGROUND OF THE INVENTION

### Description of the Related Art

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

With the advent of the e-commerce industry, there exist a myriad of online stores where product manufacturers or distributors make their products available. The demand for online purchasing is rapidly increasing with the passage of time due to several advantages associated with the technology. Firstly, orders can be placed at e-commerce websites at any point of time, as the e-commerce websites offer an “always open” store to users. Secondly, the e-commerce websites dispatch the orders at an address provided by the user.

Despite such advantages, the e-commerce websites fail to provide the customers an option to try on the garments or articles before placing the order. Everything might be available to the customers on a single click, but the fact cannot be denied that the products cannot be tried before buying. Thus, a user has to go with the option of replacing or returning of products, which may be costly or inconvenient.

What are needed are methods and apparatus that let a person see how a garment would appear on their body at a time when they do not have physical access to the garment.

### SUMMARY OF THE CLAIMED INVENTION

The presently claimed invention relates to a method, a non-transitory computer readable storage medium, and an apparatus that my execute functions consistent with the present disclosure A method consistent with the present disclosure may include receiving a selection of a garment that a user is interested in purchasing. Next, an image of the body of a user that was reflected in a mirror may be captured by a user device. Once the reflected user body image is received, points included the received body image may then be identified. Such identified user body points may correspond to joints or other bodily features of the user. Such bodily features may be referred to as salient points of the user. After the garment selection and the image of the user have been received, distances between the identified user salient points may be used to scale a size of the garment to match a distance associated with at least two of the identified user salient points. After the size of the garment has been scaled to match distances between the user salient points, a composite image may be generated that includes the selected garment superimposed over the received image of the user body image.

When the presently claimed invention is implemented as a non-transitory computer-readable storage medium, a processor executing instructions out of a memory may implement a method consistent with the present disclosure. Here again the method may include receiving a selection of a garment that a user is interested in purchasing. Next, an image of the body of a user that was reflected in a mirror may be captured by a user device. Once the reflected user body image is received, points included the received body image may then be identified. Here again, such identified user body points may correspond to joints or other bodily features of the user and such bodily features may be referred to as salient points of the user. After the garment selection and the image of the user have been received, distances between the identified user salient points may be used to scale a size of the garment to match a distance associated with at least two of the identified user salient points. After the size of the garment has been scaled to match distances between the user salient points, a composite image may be generated that includes the selected garment superimposed over the received user body image.

An apparatus consistent with the present disclosure may include an interface that receives a garment selection. In certain instances this interface may be a user interface of a user device. In other instances, this interface may be a communication interface that receives the garment selection from the user device. This apparatus may also receive an image of a user that has been reflected in a mirror. This image may be captured by a camera of the user device or may be received via the interface that received the garment selection when that interface is the communication interface. Apparatus consistent with the present disclosure may also include a memory and a processor that executes instructions out of the memory. The execution of the instructions by the processor may result in the processor identifying salient points (joints or other body features) included in an image of the user. Further execution of the instructions by the processor may then result in the processor scaling the size of a garment to match a distance between at least two of the identified salient points in the user image and then the processor may execute additional instructions to generate an image of the user that includes a composite image where the selected garment is superimposed over the received user image.

### BRIEF DESCRIPTION OF THE DRAWINGS

FIG. 1 illustrates a system for superimposing an image of a garment onto an image or video of a user that has been reflected in a mirror.

FIG. 2 illustrates different hardware and software components that may be included in a user device that performs methods consistent with the present disclosure.

FIG. 3 illustrates exemplary steps that may be performed by application program code that accesses image data from different sources when generating a composite image that may include three-dimensional (3D) features and preferred lighting.

FIG. 4 illustrates exemplary steps that may be performed to generate data associated with features included in an acquired image.

FIG. 5 illustrates a set of steps that may be performed when garment image data is overlaid over streaming data captured by a user device.

FIG. 6 illustrates exemplary steps that may be performed to generate data associated with features included in video image data.

FIG. 7 illustrates images that may be used by methods and apparatus consistent with the present disclosure that overlay an image of a garment over an image of a person.

FIG. 8 includes different sets of computer data generated superimposed over two different images of the person of FIG. 7.

FIG. 9 illustrates actions that may be performed when a transaction is process after a user has viewed a garment superimposed over an image of a person.

FIG. 10 illustrates exemplary steps that may be performed by a server that receives image data from and that provides image data to user devices.

### DETAILED DESCRIPTION

A system and a method for superimposing a garment onto an image or a real-time video of a user are disclosed. After a person captures an image or video of them self and after the person selects a garment that they wish to see them self virtually wearing, instructions executed by a processor may be used to overlay an image of the selected garment onto the image or video of the person. Methods and apparatus consistent with the present disclosure may allow a person to see how particular garments would look on them self at times when the person cannot physically access those particular garments. Images or a real-time video of the person may be captured from a reflection of the person in a mirror after which a computing device may generate a combined image of the person that depicts that person wearing a selected garment. Images of the garment overlaid over the captured images or video may show a user how the garment looks on their body from different angles or perspectives when they cannot physically touch the garment.

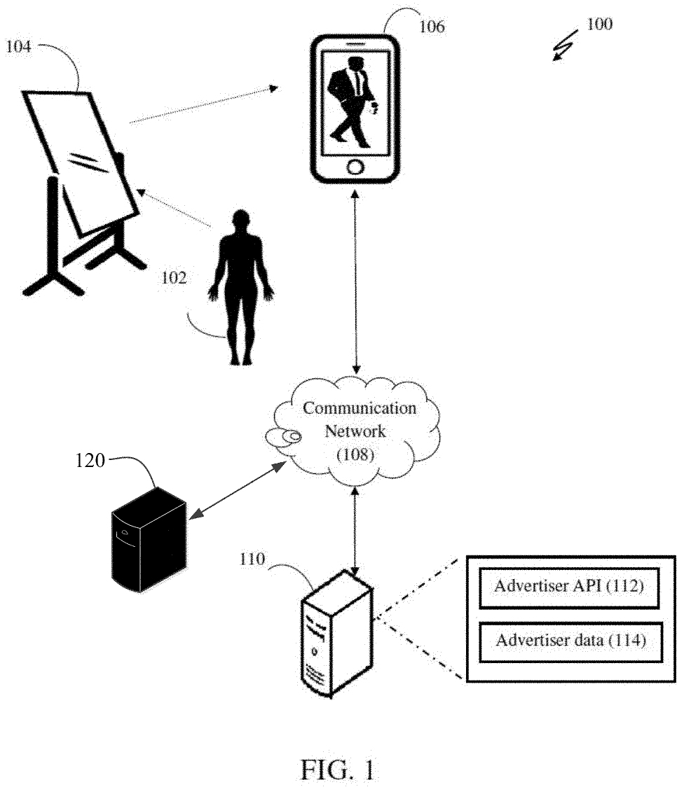

FIG. 1 illustrates a system for superimposing an image of a garment onto an image or video of a user that has been reflected in a mirror. The network connection diagram 100 of FIG. 1 includes user 102, mirror 104, user device 106, communication network 108, computer or server 110, and server 120. Such superimposed images may include rendering two-dimensional and/or three-dimensional objects on a display of a user device that appears to be mirror image of user 102 wearing a selected garment. Methods and systems consistent with the present disclosure may capture images of individuals in mirror 104 of FIG. 1. In such an instance a user may hold user device 106 (e.g. a cell phone, smart phone, wearable device, laptop computer, desktop computer, tablet computer, or other device) while the mirror reflects an image of the user. User device 106 may also be configured to receive information from one or more providers (e.g. online clothing stores) via communication network 108. This received information may include images of items that may be worn by the user. User device 106 may also be configured to capture or record still images or video of user 102 in real-time. This captured image or video data may be collected by a camera that faces mirror 104. Images captured by the camera may be displayed on a display associated with user device 106. Computer 110 may be a server that stores advertiser application programs, such as application program interface (API) 112 of FIG. 1. Computer 110 may also store and advertiser data 114. In certain instances advertiser data 114 may include images and other information of wearable items that may be purchased from a provider.

Communications received from computer/server 110 may be received via any form of communication network 108. As such network 108 may be a wired or wireless network, including, yet not limited to Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication networks known in the art.

In certain instances an application program such as API 112 may be downloaded onto user device 106, when required. In such an instance, a user reviewing a website of a provider using user device 106 may be informed that application program API 112 must be downloaded and installed on user device 106 before they may view virtual garments overlaid on images of them self. User device 106 may be linked to an application store or application provider (such as the Apple™ app store or the Android™ app store) from which user device 106 may download API 112.

Server 120 may be a computer that stores information that may be used to process user orders, provide advertisements, store acquired image data, or be a server of a data sharing platform. In certain instances, the functionality performed by server 120 may be implemented by server 110 or such functionality may be performed by various different computers that may be administrated by different entities. When server 120 processes orders, user 102 may provide payment information via user device 106 to purchase a garment that user 102 has decided to buy. Overlaid images reviewed by user 102 may be stored in a database at server 120 such that these overlaid images may be viewed at a later time by user 102 or these images may be shared with friends or associates of user 102 via a social media platform (e.g. Facebook, Twitter, or WhatAPP). In certain instances user 102 may collaborate with a vendor that sells garments. In such an instance, user 102 may store sets of overlaid images or videos at server 120 of them self wearing virtual garments. These images or video may then be shared with others as part of a virtual fashion show or “fit event.” Any garment sale made after individuals have viewed the image or video of user 102 may cause the vendor to compensate user 102 for helping to sell their garments or user 102 could be compensated each time their images or video is viewed, “shared,” or “liked” by other users.

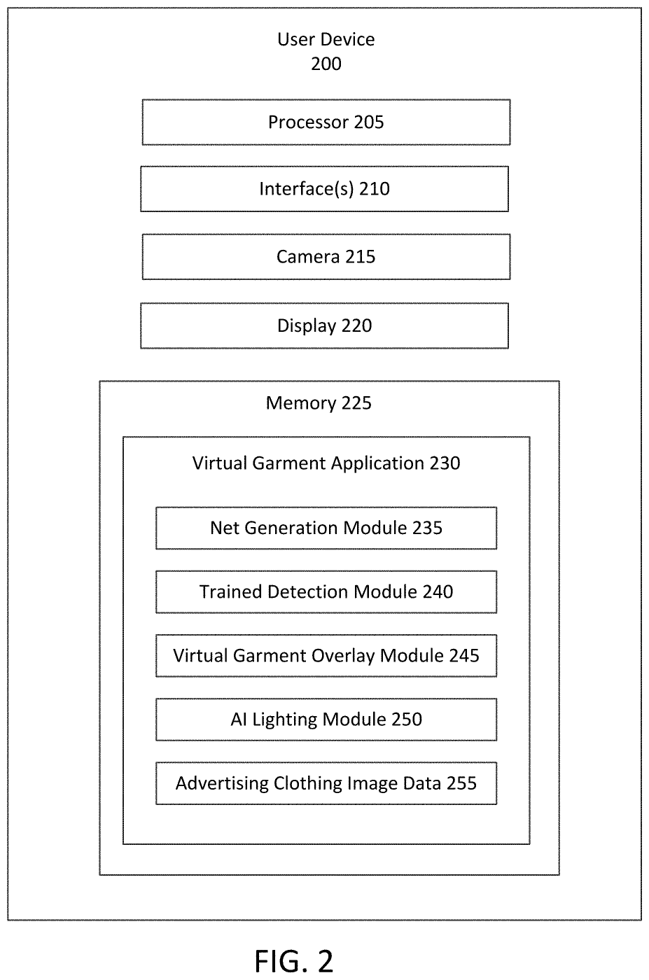

FIG. 2 illustrates different hardware and software components that may be included in a user device that performs methods consistent with the present disclosure. User device 200 of FIG. 2 includes processor 205, interface(s) 210, camera 215, display 220, and memory 225. Memory 225 of FIG. 2 is illustrated as storing virtual garment application program code 230 that may include instructions that may be executed by processor 205 when performing functions consistent with net generation module 235, trained detection module 240, virtual garment overlay module 245, and artificial intelligent (AI) lighting module 250 of FIG. 2. Memory 225 of FIG. 2 is illustrated as storing advertising clothing image data 255. While the virtual garment application 230 of FIG. 2 is illustrated as including software or program code modules 235, 240, 245, 250, and 255, functions of these different software modules may be implemented as one or more sets of program code. As such, modules 235, 240, 245, 250, and 255 of FIG. 2 may be types of functions performed by apparatus or methods consistent with the present disclosure. The different modules of FIG. 2, while illustrated as separate modules, are exemplary and are not intended to limit the architecture of virtual garment application 230 to a structure that requires multiple different software or program code modules.

The processor 205 may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor). The processor 205 may be configured to execute one or more computer-readable program instructions, such as program instructions to carry out any of the functions described in this description, interface(s) 210 may assist an operator in interacting with the system. Interface(s) 210 of the may accept an input from the operator, provide an output to the operator, or may perform both the actions. Interfaces 210 may be a command line interface (CLI), a graphical user interface (GUI), or a voice/sound interface (e.g. a speaker and microphone). Interfaces 210 may also include network communication interface that send and receive data to other computing devices using wireless or wired communications. As such, interfaces 210 may include a Wi-Fi 802.11 interface, a cell phone interface, a Bluetooth interface, an Ethernet interface, or other type of communication interface. Communication interfaces included in user device 200 may receive images of garments from computer/server 110 of FIG. 1 when a user of user device 200 wishes to view a computer generated image of them self “trying on” (virtually wearing) a particular garment.

Memories 225 included in user device 200 may include a fixed (hard) disk drive, FLASH memory, optical disks, and magneto-optical disks, semiconductor memories, read only memories (ROMs), random access memories (RAMs), programmable read-only memories (PROMs), erasable PROMs (EPROMs), electrically erasable PROMs (EEPROMs), magnetic or optical cards, or other type of media/machine-readable medium suitable for storing electronic instructions. Memory 225 may be used to store one or more sets of program code. These sets of program code may include net generation module 235 and trained detection module 240 that include instructions that when executed by a processor may identify points in an image of a person and may identify distances between those different points. Instructions associated with virtual garment overlay module 245 may cause a processor to identify a garment size to fit over the image or video of the user. Once a garment size is identified, the execution of program code may overlay an image of the garment over the image of the user. The processor executing instructions consistent with the AI lighting module 250 of FIG. 2 may generate an image consistent with lighting preferences that were included in a set of data received with the image of the garment (e.g. the advertising clothing image data 255 of FIG. 2) when a combined image of the garment and the user are adjusted. Such lighting preferences may identify attributes that could include a color, a brightness, a contrast, or a sharpness of the garment included in the combined image of the garment and the user. This overlaying process may include optimizations commonly referred to as “ambient occlusions.” The process of generating ambient occlusions may include identifying an exposure or lighting of various points of an object in respect other objects that surround the object for which lighting is being adjusted. Such lighting adjustments may enhance contrasts included in an image. These enhancements may cause overly bright areas of an image to darken certain. In certain instance these darkened areas may correspond to areas of the image that are blocked from an ambient light source that illuminates an image. For example, locations near a wrinkle of a shirt in an image may be darkened when making a computer generated composite image that includes shadows that appear natural.

In certain instances a user may select an ambient occlusion profile from a plurality of ambient occlusion profiles stored in the AI lightning module 220 of FIG. 2. In yet another instance, a user may want to view a 3D virtual garment with lighting other than the real-world lighting in which the image or streaming image data is captured. For instance, a user might wish to view a bathing suit with an ambient occlusion profile of a simulated beach lighting (e.g. natural sunlight) from a specific angle that simulates light from the sun at a specific time of the day. In yet another instance, the user may wish to view a dinner jacket with an ambient occlusion profile of a simulated restaurant lighting (e.g. candlelight) and lighting effects of composite images may adjusted based on a selection of a candlelight lighting profile. After such selections or detection of the ambient occlusion, the virtual garment application program may display the image data or streaming image data and the 3D virtual garment with the selected ambient occlusion or lighting profile may be viewed by the user. In such instances, display 208 of the user device 200 may show the user wearing a selected 3D virtual garment with a selected lighting profile. When streaming image data is used to create composite images and when the user moves, the streaming image data may be updated to display the user movements.

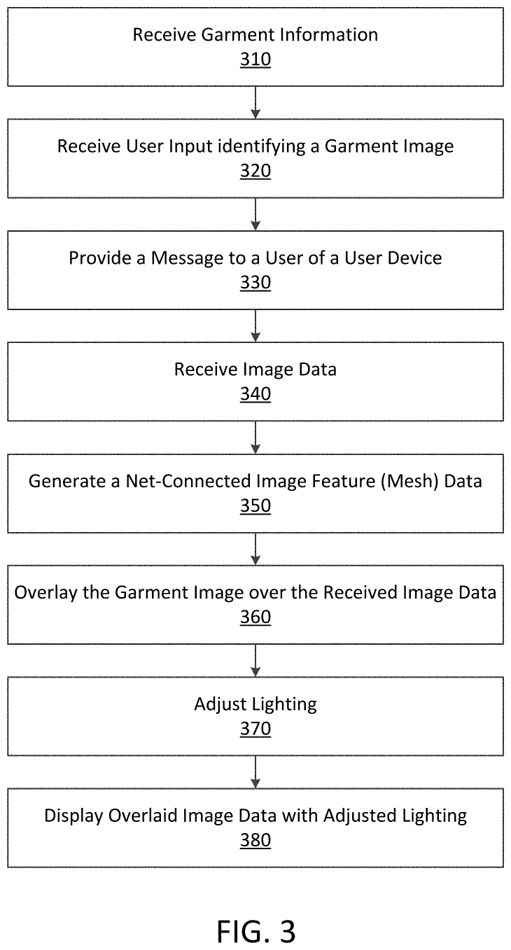

FIG. 3 illustrates exemplary steps that may be performed by application program code that accesses image data from different sources when generating a composite image that may include three-dimensional (3D) features and preferred lighting. The steps included in FIG. 3 may be consistent with functions performed by the virtual garment application program 230 of FIG. 2. Composite images generated by methods and apparatus consistent with the present disclosure are virtual depictions that approximate how a user would appear if they were actually wearing a garment selected by the user. Step 310 of FIG. 3 is a step where garment information may be received, stored, or accessed. In certain instances, this garment information may be received from one or more vendors that sell garments. Computer or server 110 of FIG. 1 may initially receive and store the garment image data from a vendor or multiple vendors when computer 110 provides a service that allows vendors to sell their garments using methods consistent with the present disclosure. Alternatively or additionally, computer 110 may store garment data from a company that controls the operation of computer 110 when selling their own garments. Garments consistent with the present disclosure include, yet are not limited to, any item that may be worn by a person or that may be integrated into or onto the body of a person. As such, garments may include clothing, tattoo art, piercings, jewelry, glasses, eye patches, colored contact lenses, hats, helmets, uniforms, costumes, cosmetic surgery articles, skin tanning lotion, spray treatment products, hair styles, hair dyes, hair plugs, wigs, dental implants, and other articles.

Garment information received by or stored at computer 110 may include images of garments, garment lighting preferences, garment prices, garment sizes/dimensions, and/or shopping/order data. A user device, such as user device 106 of FIG. 1 may receive garment information from computer 110 in step 310 of FIG. 3. In such an instance, this garment information may be received via communication network 108 of FIG. 1 and interface 210 of FIG. 2. In instances where a user device does not currently store program code capable of performing functions consistent with the present disclosure, application program code such as API 112 of FIG. 1 or virtual garment application program code 230 may be downloaded onto a user device such as user device 106 of FIG. 1 or user device 200 of FIG. 2. In certain instances, advertisers could prepare clothing images and other related data (e.g. price information, sizing/dimensional information, or other shopping information) that can be stored as sets of advertiser data 114 at computer 110 of FIG. 1. When a user of a user device selects a garment via an advertiser program, such as API 112 of FIG. 1, an image of the user wearing the selected garment may be generated by methods consistent with the present disclosure. In such instances, the generated image may include a mirrored view of the selected garment.

Step 320 of FIG. 3 may be a step that receives user input that identifies a garment selected by a user of a user device. Next in step 330 a prompt or message may be provided to a user of the user device that informs the user to look in a mirror and capture an image or video of them self or of a friend that wishes to see how a particular garment would look if they wore that garment. Then in step 340 of FIG. 3, image data of the user or other person may be received. The image data received in step 340 may include advertiser data 114 of FIG. 1. This advertiser data may include images of garments, garment sizing or dimensional information, and pricing information. A user of a particular type of user device may also be prompted to use a specific camera associated with a particular type of device. In such an instance, a user may be instructed to use the backside camera of an IPhone 5 because the backside camera of this particular model of phone has superior image capturing capabilities (e.g. higher resolution sensor, sensor size, lens shape/size, or improved sensor lighting dynamic range characteristics) as compared to a front side camera of the IPhone 5. As such, methods consistent with the present disclosure may recommend a preferred camera to capture images when a user device includes multiple cameras with different characteristics or specifications. In certain instances a user of a user device may also identify which hand that they are holding the user device used to capture this image or video data. Selections that identify a hand left versus right may identified by a user speaking into a microphone or by the user providing a response via a graphical user interface (GUI) provided on a display of the user device. One potential benefit provided by such user feedback that identifies a hand that held the camera used to capture image data is that software that performs an overlaying function be implemented with fewer program instructions. Alternatively, a user may not be required to identify a hand with which they hold a camera that acquires an image. Furthermore, the camera that acquires image data may not be held by a person upon whom an image of clothing will be overlaid.

In certain instances two or more cameras may be used to collect images or video of a user when garments are overlaid over the images of the user. Multiple cameras could allow for true 3D data to be provided to a user via their user device or via a wearable 3D virtual reality device, such as the Microsoft Hololens. In such instances, 3D images may be viewed on a conventional display using 3D glasses or may be viewed on a wearable 3D virtual reality device. The Microsoft Hololens and similar devices allow users to view 3D images on displays that are worn on the head of a person.

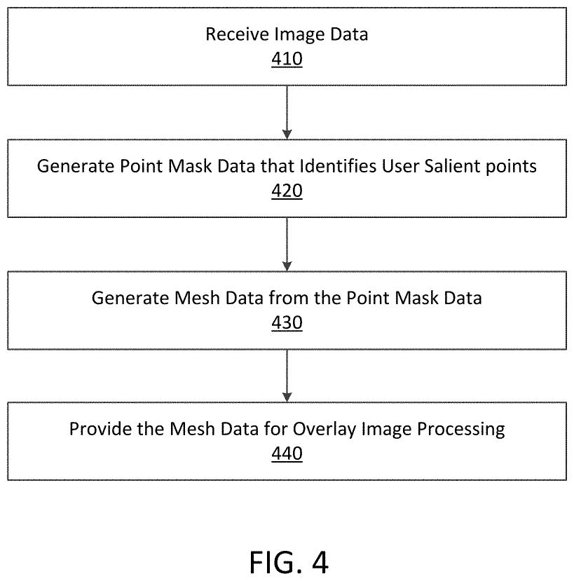

After image data has been received in step 340 of FIG. 3, program code consistent with net generation module 235 of FIG. 2 may be executed in step 350. The operation of this net generation program code may result in the construction of net-connected feature data set that may be referred to as mesh data that includes net-connected features. Such net-connected features may include features or ‘salient points’ of a person that are connected with interconnecting lines that may be used to form stick-figure proportioned to dimensions of a user in the received image data. These features or salient points may correspond to joints or to critical areas of a person. Salient points may be located at joint (e.g. wrist, the elbow, hip, shoulder, knee, or ankle) or may be located with other body features (e.g. the neck, chest center, eyes, nose, mouth, chin, waist, feet, hands or ears) of a person. Distances between different salient points may correspond to the length of a person's arm, the length of a person's leg, the width of a person's chest, the length of a person's torso, a separation of a person's eyes, or a distance from an eye of the person to the ear of that person. One or more of such distances may be identified by operation of program code that generates the net-connected image feature data in step 350 of FIG. 3. Further steps associated with the generation of the net-connected image feature (‘mesh’) data is described in respect to steps included in FIG. 4 of this disclosure and these steps may perform functions consistent with operation of net generation module 235 of FIG. 2.

Next in step 360 of FIG. 3, garment image data may be combined with the received image data when a composite image is generated by combining features associated with the selected garment and features include in the acquired image data. Step 360 may select a garment size that corresponds to distances that may have been identified in step 350 of FIG. 3. In an instance where a user is wearing a shirt in an acquired image when the user wishes to view how they would appear wearing a shirt offered by a vendor. The composite image may be generated by using lighting from an image of the offered shirt and with curves or wrinkles included in the acquired image of the person. Operations consistent with step 360 may be performed by the virtual garment overlay module 245 of FIG. 2. The image of the offered shirt may include dimensions that coincide with a size closest to dimensions in step 350 of FIG. 3 or dimensions of the offered shirt may be customized based on dimensions identified in step 350 of FIG. 3. After step 360 of FIG. 3, lighting of the composite overlaid image may be adjusted in step 370 to address any anomalies such that the composite image displays the garment according to one or more preferences. For example, the color, lighting, brightness, contrast, or sharpness of an image of a garment may be given preference over color, lighting, brightness, contrast, or sharpness of an acquired image of the person when the composite image is generated. Such preferences may be identified by attributes in a set of program code or may be identified by vendors that provide garment images. In certain instances, the color, lighting, brightness, contrast, or sharpness of one image may be blended with the color, lighting, brightness, contrast, or sharpness of another image such that a resultant composite image appears more natural. For example, in an instance when a person wishes to view an image of them wearing a shirt and a pair of pants attributes of the shirt and the pants may be adjusted when a composite image is generated that includes the person virtually wearing both the shirt and the pants. Operations performed in step 370 of FIG. 3 may be performed by program code of AI lighting module 250 of FIG. 2. In certain instances, the AI lighting module may detect ambient lighting conditions in an acquired image or real-time video and this ambient lighting may be used to generate shading or shadowing effects through processes that generate “ambient occlusions” in the acquired image or video.

The process of generating ambient occlusions may include calculating an exposure or lighting of various points of an object in respect other objects that surround the object for which lighting is being adjusted. Such lighting adjustments may enhance contrasts included in an image that cause an image that initially appears to be over exposed or overly bright to darken certain parts of an image. These darkened areas may correspond to areas in an image that are blocked from an ambient light source. For example, locations near a wrinkle of a shirt in an image may be darkened when making a computer generated composite image appear as if the wrinkle caused a shadow to appear in the image of a shirt. This generated shadow may approximate a real shadow that would appear in a real image of a person wearing a clothing item that was illuminated by light from an ambient light source. Next in step 380 an image that includes the selected garment overlaid on the acquired image of the person may be displayed on a display of a user device. This displayed image may include lighting adjusted in step 370 of FIG. 3. While not illustrated in FIG. 3, a user of a user device may order and purchase selected garments.

While the steps illustrated in FIG. 3 have been discussed in respect to operations performed by a user device, some of these operations may be performed at an external computing device, such as computer 110 of FIG. 1. In such instances, a user device may receive user garment selections and user image data, these selections may be sent to computer 110, and computer 110 may generate composite images consistent with the present disclosure. Computer 110 could then provide the generated composite images to the user device for display on a display of the user device. As such, certain operations of the present disclosure may be performed by computing devices that are optimized for computations and image generation. In such instances other operations may be performed performed by a user device, where these other operations may be limited to less compute intensive tasks of receiving selections, sending data, receiving image data from computer 110, and to displaying the received image data.

In instances when the generation of composite images includes motion, streaming video data captured by a user device may be combined with images of a selected garment. In such instances, step 350 of FIG. 3 may also identify positions of a user as that user moves and step 360 may overlay the garment image data over received image data continuously over a span of time. Such operations could occur in real-time or near-real-time or video data could be acquired after which a video of the person wearing the selected garment may be viewed after a composite video has been generated. Here again, the generation of composite images may be performed at a user device or may be performed at least partially by a remote computer system.

The overlaying of garment image data over received image data may also result in textures included in a captured image being migrated to an image of a garment that is superimposed (overlaid) over the captured image. This may cause, wrinkles included in an original image to be migrated to a composite image that shows the garment superimposed over the body of a person included in the original image. The textures imported from an original image may be augmented by adding shadows consistent with the generation of optical occlusions previously discussed.

In another example, an original image includes the forearm of a person may be combined with a selection of a tattoo. Surface features of the person's skin or muscularity (skin textures) could be included in a composite image that also includes the tattoo. The superimposed image may also include colors or other preferred features that are associated with tattoo image data received from a data store. Such a composite image would retain characteristics and texturing of the original image and could include preferred features identified by the tattoo image data.

FIG. 4 illustrates exemplary steps that may be performed to generate data associated with features included in an acquired image. The steps performed in FIG. 4 may be consistent with steps 340 and 350 of FIG. 3. Here, operations performed in step 350 may be performed by executing instructions consistent with the net generation module 235 of FIG. 2. Step 410 of FIG. 4 may receive the acquired image data and step 420 may identify the features or salient points when generating a point mask data that identifies user salient points. This generation of this point mask may associate user salient points with locations within the received image data and this point mask may include superimposing dots over these salient points of a person as part of a process that can also generate the stick-like figure discussed in respect to FIG. 3. Next in step 430, mesh data may be generated from the point mask data. As discussed in respect to FIG. 3, this mesh data may also be referred to a net-connected image feature data set. This mesh or net-connected image feature data may include distances or other data that may be used in step 360 of FIG. 3 when garment image data is overlaid over the received image data. As such step 440 of FIG. 4 may provide generated mesh data to step 360 of FIG. 3 such that overlay image data can be processed into a composite image.

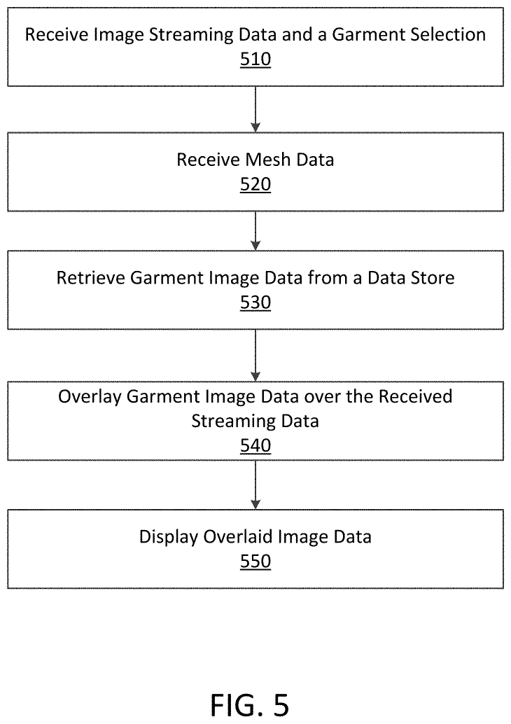

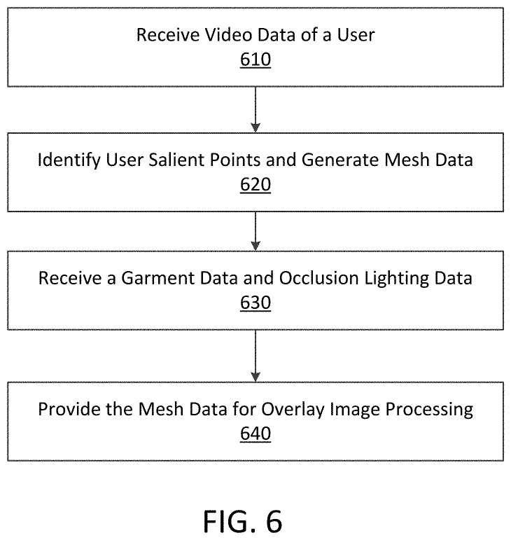

FIG. 5 illustrates a set of steps that may be performed when garment image data is overlaid over streaming data captured by a user device. FIG. 5 includes step 510 where image streaming data and a garment selection are received by or from a user device. This receive image data may be a video of a user as that user moves in 3D space. Next in step 520 of FIG. 5, mesh data may be received. The mesh data received in step 520 may include information mesh data generated by processes consistent with step 420 and/or step 430 of FIG. 4 or step 630 of FIG. 6. This mesh data may also be generated in a manner consistent with the generation of the net-connected image feature data generated in step 350 of FIG. 3.

After step 520, step 530 of FIG. 5 may retrieve garment image data from a data store (e.g. a memory or database) before overlaying the retrieved garment image data over the received streaming data. This data may have been retrieved from computer 110 of FIG. 1 and may include data provided by an advertiser (advertiser data 114 of FIG. 1). Any of the actions consistent with operations discussed in respect to FIGS. 3-4 of this disclosure may also be performed when generating data or when overlaying garment image data over data captured by a user device in FIG. 5. The retrieved image data may include image data of different sides of a garment. For example a set of garment image data may include a front view, one or more side views, and a back view of the garment. In such instances, mesh data may include data associated with user salient points or distances between user salient points when composite images are generated. After step 540, overlaid image data may be provided to or displayed on a user device. As previously mentioned in respect to FIG. 3, image or video data may be generated by operations performed in whole or in part at user device. Here again, image processing and/or generation functions may be performed at computer 110 of FIG. 1 and video data may be provided to a user device for display.

FIG. 6 illustrates exemplary steps that may be performed to generate data associated with features included in video image data. FIG. 6 includes steps that are similar to steps discussed in respect to FIG. 4. Step 620 may identify and track salient points of a user as the user moves. These salient points may be used to generate mesh data in a manner similar to methods discussed in respect to FIG. 4. As such, step 620 of FIG. 6 may generate point mask data that includes the identified salient points and may generate the mesh data from the point mask data. Next in step 630 of FIG. 6, garment data and occlusion lighting data preferences may be retrieved from a data store or from a user. After step 630, the generated mesh data may be provided to step 520 of FIG. 5, such that a video can be generated that includes a garment overlaid over images of a user as the user moves. Functions consistent with FIG. 6 may be performed by execution of program code of the virtual garment overlay module 245 of FIG. 2.

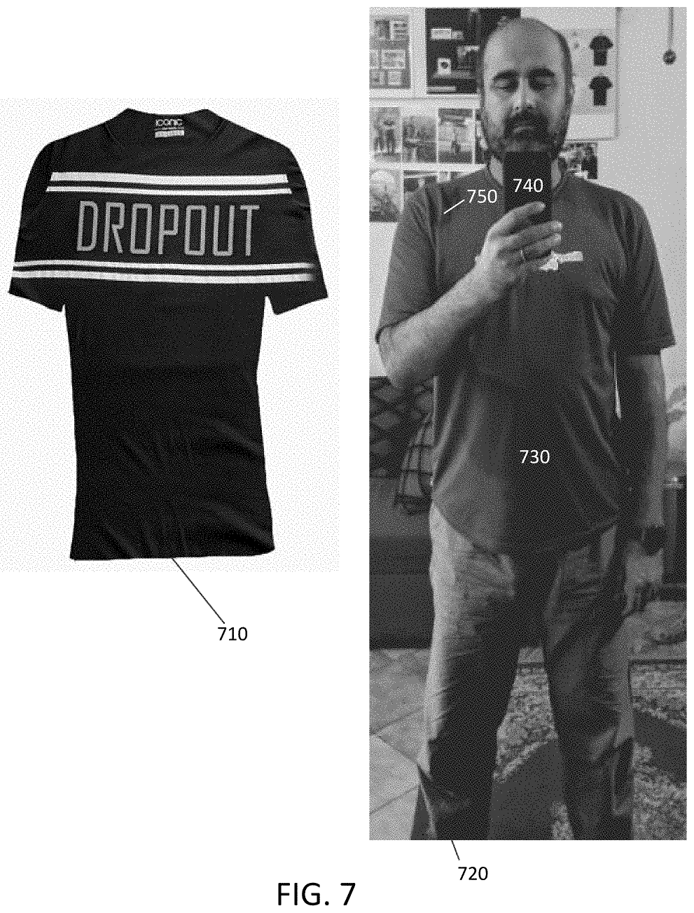

FIG. 7 illustrates images that may be used by methods and apparatus consistent with the present disclosure that overlay an image of a garment over an image of a person. FIG. 7 includes an image of a garment 710 that is a black shirt with horizontal stripes and gray text. FIG. 7 also includes an image 720 of a person holding user device 740. The image may have been captured by the person taking a photograph or video using a camera of user device 740. Note that image 720 also includes a gray shirt 730 and wrinkles 750 on the surface of the shirt 730.

The image of garment 710 may have been selected by a user of a user device that wishes to “try on” a virtual garment. After such a selection garment data may be downloaded onto their user device and that data may include garment images, garment image preferences, garment prices, garment sizes/dimensions, or shopping/order data. In certain instances, garment image preferences may identify one or more of preferred color, lighting, brightness, contrast, or sharpness metrics. After a user selects a garment, a message may be provided to a user of a user device to take a photograph or video of them self when looking in a mirror. This may result in image 720 of FIG. 7 being acquired. FIG. 7 illustrates images that may be displayed on a display at a user device when steps 320 through 340 of FIG. 3 are performed.

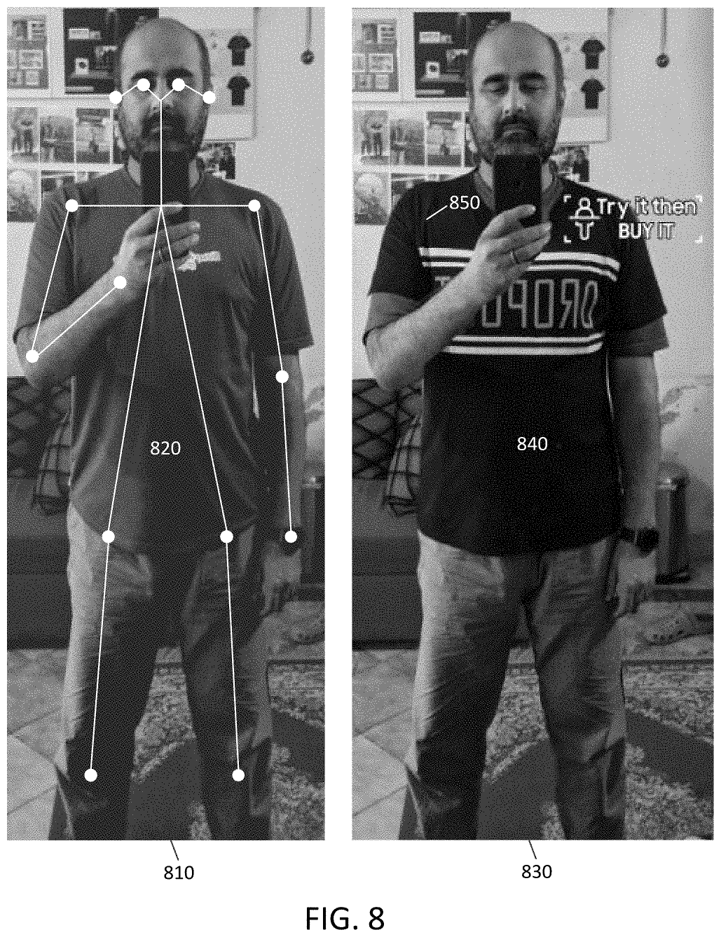

FIG. 8 includes different sets of computer data generated superimposed over two different images of the person of FIG. 7. Image 810 of FIG. 8 includes a series of white dots located on salient points of the person that is considering whether to purchase garment 710 of FIG. 7. Salient points included in FIG. 8 are located at the person's knee joints, hip joints, shoulder joints, elbow joints, wrist joints, ankle joints, and ears. Each of the salient points in image 810 are connected with white lines that form a stick figure that may generally correspond to the bone structure of the person in image 810. Image 810 is a visual representation of items that may have been identified by the steps illustrated in FIG. 4.

Information that identifies the relative location of each of the white dots to respective salient points of the person of image 810 are a form of point mask data consistent with the present disclosure. A processor executing program code consistent with the present disclosure may partition the image of the person 720 in FIG. 7 to a series of coordinates in two or three dimensional space. Execution of the program code may identify coordinates for each of the salient points of the person, and those salient points may be represented by the white dots in image 820 of FIG. 8. Operation of the program code may then connect salient points along contours or portions of the body of the person when generating the white lines of image 810 that connect the salient points when image 810 is generated. The person illustrated in FIGS. 7 & 8 may never see the stick figure illustrated in image 810, yet data associated with the stick figure of image 810 may be used to identify distances between salient points that may in turn be used to identify a garment size associated with the person of FIGS. 7 & 8. In certain instances, the net-connected (stick figure) image illustrated in image 810 may be displayed on the display of a user device. Such a net-connected image may also be displayed over an image in step 380 of FIG. 3 or step 550 of FIG. 5. As such, image 830 may include the stick figure illustrated in image 810 and an image of garment 710 of FIG. 7.

In respect to the steps of FIG. 4, the salient points of image 810 are used to generate a point mask data set that includes relative coordinates of salient points in an image of a person as discussed in respect to FIG. 4, step 420. As such, a set of point mask data may include a set of coordinates in two or three dimensional space. The lines illustrated in image 810 may be used to identify distances between particular salient points of a person. These distances may be included in a set of mesh data as discussed in respect to step 430 of FIG. 4 and step 350 of FIG. 3. At this point in time, further execution of the virtual garment application program code may scale information from data associated with image 710 to match distances between certain relevant salient points of the person when generating image 830 of FIG. 8. Note that image 830 includes shirt 830 that is the same shirt that is included in image 710 of FIG. 7. Note also that shirt 840 also includes wrinkles 850 that are the same as or that are similar to the wrinkles 750 of shirt 730 of FIG. 7. Note also that the shirt 840 of image 830 is a mirror image of shirt 710 of FIG. 7.

Image 830 may have been generated using one or more preferences associated with garment 710 of FIG. 7. Here again, these preferences may be part of a set of garment data that may have been identified by a vendor or seller of garment 710 or these preferences may be selected by a user. Program code of a virtual garment application may be configured to map features included in a surface of an original acquired image when generating image 830. This mapping of surface features may cause textures like the wrinkles 750 of FIG. 7 to be included in a generated image of a person wearing shirt 840 using colors, lighting, brightness, contrast, or sharpness identified in a set of information associated with a garment such as garment 710 of FIG. 7.

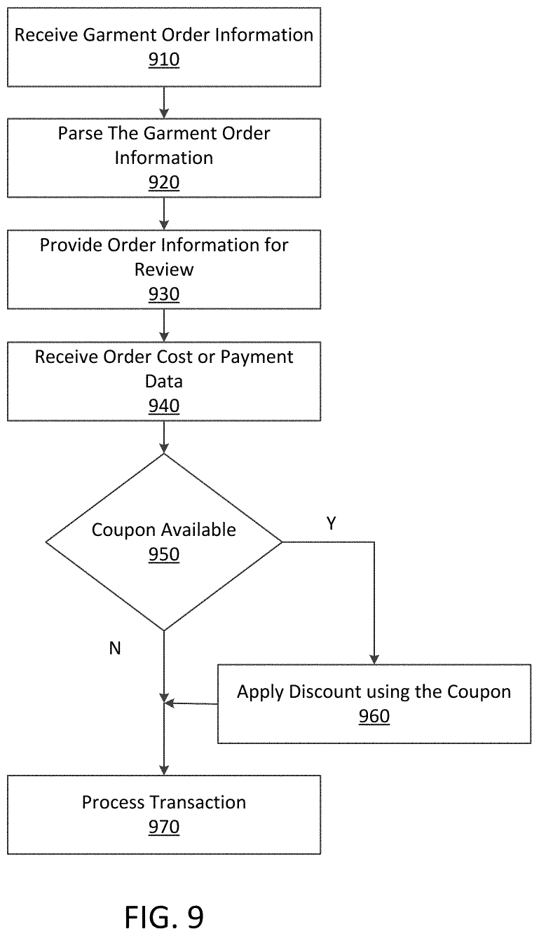

FIG. 9 illustrates actions that may be performed when a transaction is processed after a user has viewed a garment superimposed over an image of a person. Step 910 of FIG. 9 is a step where order information may be received from a user. This received order information may be reviewed or parsed in step 920 after which a summary of the order information may be provided to a user device such as user device 106 of FIG. 1 or 200 of FIG. 2. Next, in step 940 of FIG. 9 cost or payment information may be received. This cost or payment information may include credit card account numbers and/or delivery information.

Determination step 950 may then identify whether the user has a coupon that can be applied to receive a discount on the order. When a coupon is available program flow may move to step 960 where the discount associated with the coupon may be applied to the purchase. In instances when the user does not have a coupon to apply or after the user has provided coupon information via their user device, a transaction related to the received order may be processed in step 970 of FIG. 9.

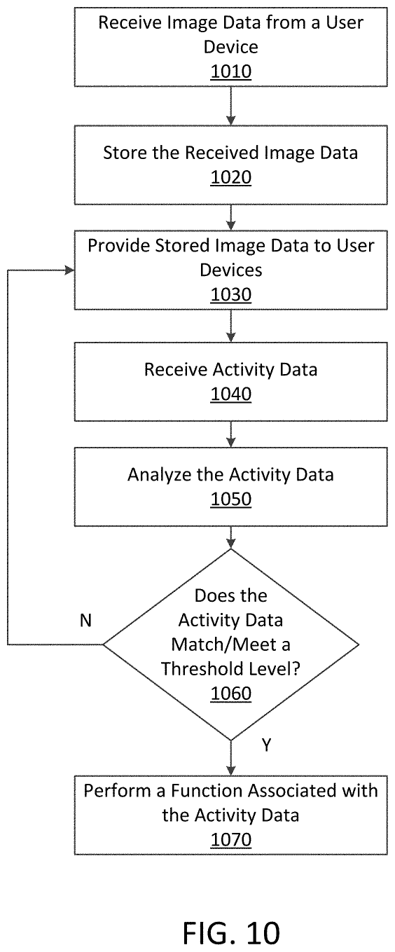

FIG. 10 illustrates exemplary steps that may be performed by a server that receives image data from and that provides image data to user devices. The steps illustrated in FIG. 10 may be performed by a server of a social media platform like Facebook. Step 1010 of FIG. 10 may receive image and other data from a user device. This received image data may include garments that have been overlaid over an image of a first user statically or dynamically that. Static image data may be one or more discrete images that do not show motion of a user and dynamic image data may include video data that shows the user moving. Such static or dynamic image data may also include text or audio data that may be provided to users that view images stored at a server.

In certain instances a user that provides image data to the server (an originating user) may have provided that image data for storage. FIG. 10 illustrates exemplary steps that may be performed by a server that receives image data from and that provides image data to user devices for viewing at a later time. This may allow the originating user to buy a garment at a later time. In other instances the originating user may provide image data to the server for the server to share with other, followers or friends of the user that provided the images. The image data received in step 1010 of FIG. 10 may have been captured as part of an event where the originating user selects garments to be overlaid over images of them self. After the originating user is satisfied with images captured, that originating user may send the captured images for storage at the server. After the image data is received in step 1010, it may be stored in a memory or database in step 1020 for later retrieval or sharing. In instances when the user originating user acts as an advertiser, they may provide an indication that the stored image data may be shared with other user devices. Next in step 1030 of FIG. 10, the stored image data may be provided, upon request, to a user device of originating user or the stored image data may be provided to other user devices. After step 1030, activity data may be received in step 1040 of FIG. 10. This activity data may be related to actions performed by the user that provided the received image data or to actions performed by followers or friends of that user. Next in step 1050, the received activity data may be analyzed to see if the activity data matches a threshold level. When the activity data does not match a threshold level, program flow may move back to step 1030 of FIG. 10. When determination step 1060 identifies that the activity data does match or meets a threshold level, program flow may move to step 1070 where a function associated with the activity data may be performed.

As mentioned above, activities received and analyzed in FIG. 10 may include actions performed by a user that has provided images (an originating user). Actions performed by the user such an originating user may include the originating user identifying that they wish to purchase a garment included in the image data, may include an identification that the originating user has moved, or may include voice inputs made by the originating user when image data was acquired, processed, or displayed. The receipt of an indication that the a user wishes to purchase a garment may be sufficient enough for determination step 1060 to identify that the user activity has met a threshold level and the user may be directed to processes consistent with FIG. 9 to process an order of a selected garment. In certain instances rapid motion of a user or loud vocal reaction made by an originating user in a video may also be identified as matching a threshold level in step 1060 of FIG. 10. The meeting or matching of such a threshold may cause alerts to be sent to other users identifying the video or moments in the video that include the rapid user motion or the loud vocal reaction. As such, rapid motions and audio sounds meeting threshold requirements may be triggers to share received image data with other users.

As also mentioned above, activities received and analyzed in FIG. 10 may include actions performed by other users that viewed images provided by an originating user. In such instances metrics that may be used to identify that an activity level has been matched or met may correspond to a number of positive comments (e.g. social media likes), a number of views, a number of social media messages sent from one user to another (e.g. social media shares), or a purchase of garments included in the image data. In such instances a function performed when a threshold is matched or met may include providing compensation (e.g. monies or coupons) to the originating user from which the image data was received.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASH EPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations into fewer steps, include additional steps, or overlap certain operations, etc.).

What is claimed is:

1. A method for generating images, the method comprising:
receiving a selection of a garment;
receiving an image of a user that has been reflected by a mirror;
identifying at least two salient points of the body of the user;
scaling a size of the garment to match a distance between the at least two salient points of the body of the user; and
generating an image of the user that includes the selected garment scaled to the size that matches the distance between the at least two salient points.

2. The method of claim 1, further comprising:
identifying a feature included in the received user image; and
displaying the generate image of the user that includes the selected garment, the generated image including the feature identified in the received user image and including a display preference associated with the selected garment.

3. The method of claim 1, further comprising receiving an application program from a server, the application program including program code associated with overlaying an image of the selected garment on the received image of the user.

4. The method of claim 1, further comprising receiving data associated with the garment, the received garment data identifying display preference for displaying the garment on the received image of the person.

5. The method of claim 1, further comprising allowing image data from one or more vendors to be received such that the user can select one or more garments from the received garment image data.

6. The method of claim 1, wherein the image of the user is captured by a camera at a user device and the method further comprises:
sending the received user image to an external computer that scales the size of the garment and that generates the image that includes the selected garment scaled to the size that matches the distance between the at least two salient points;
receiving the generated image; and
displaying the generated image.

7. The method of claim 1, further comprising adjusting lighting of one or more points in the generated image.

8. The method of claim 1, further comprising identifying at least one portion in the generated image to include a shadow, the identification based on a preference associated with a location of an ambient light source, wherein the generated image includes the shadow.

9. The method of claim 1, wherein the received user image is a video and the generated image includes a depiction of the user wearing the garment as the user moves in the video.

10. A non-transitory computer-readable storage medium having embodied thereon a program executable by a processor to implement a method for generating images, the method comprising:
receiving a selection of a garment;
receiving an image of a user that has been reflected by a mirror;
identifying at least two salient points of the body of the user;
scaling a size of the garment to match a distance between the at least two salient points of the body of the user; and
generating an image of the user that includes the selected garment scaled to the size that matches the distance between the at least two salient points.

11. The non-transitory computer-readable storage medium of claim 1, the program further executable to:
identify a feature included in the received user image; and
display the generate image of the user that includes the selected garment, the generated image including the feature identified in the received user image and including a display preference associated with the selected garment.

12. The non-transitory computer-readable storage medium of claim 1, the program further executable to receive an application program from a server, the application program including program code associated with overlaying an image of the selected garment on the received image of the user.

13. The non-transitory computer-readable storage medium of claim 1, the program further executable to receive data associated with the garment, the received garment data identifying display preference for displaying the garment on the received image of the person.

14. The non-transitory computer-readable storage medium of claim 1, the program further executable to allow image data from one or more vendors to be received such that the user can select one or more garments from the received garment image data.

15. The non-transitory computer-readable storage medium of claim 1, wherein the image of the user is captured by a camera at a user device and the program further executable to:
send the received user image to an external computer that scales the size of the garment and that generates the image that includes the selected garment scaled to the size that matches the distance between the at least two salient points;
receive the generated image; and
display generated image.

16. The non-transitory computer-readable storage medium of claim 1, the program further executable to adjust lighting of one or more points in the generated image.

17. The non-transitory computer-readable storage medium of claim 1, the program further executable to identify at least one portion in the generated image to include a shadow, the identification based on a preference associated with a location of an ambient light source, wherein the generated image includes the shadow.

18. The non-transitory computer-readable storage medium of claim 1, wherein the received user image is a video and the generated image includes a depiction of the user wearing the garment as the user moves in the video.

19. An apparatus for generating images, the apparatus comprising:
an interface that receives a selection of a garment, wherein an image of a user that has been reflected by a mirror is received via at least one of a camera or the interface;
a memory; and
a processor that executes instructions out of the memory to:
identify at least two salient points of the body of the user;
scale a size of the garment to match a distance between the at least two salient points of the body of the user; and
generate an image of the user that includes the selected garment scaled to the size that matches the distance between the at least two salient points.

20. The apparatus of claim 19, further comprising the camera that receives the user image, wherein the interface is a user interface that receives the garment selection based on an image of the garment received from an external computer via a communication interface.
